(19) United States
(12) Patent Application Publication
(10) Pub. No.: US 2026/0342364 A1
(43) Pub. Date: Oct. 29, 2026

(54) ACTIVE DISTRIBUTED ANTENNA COMMUNICATING METHOD AND SYSTEM FOR MULTI MIMO SIGNAL TRANSMISSION OVER TRADITIONAL PASSIVE DISTRIBUTED ANTENNA SYSTEM

(71) Applicant: Amoeso Co., Ltd., Hsinchu City (TW)

(72) Inventors: LEE-CHUAN CHANG, Hsinchu City (TW); Chuang-Chun Chiou, Hsinchu City (TW)

(21) Appl. No.: 19/193,402

(22) Filed: Apr. 29, 2025

(30) Foreign Application Priority Data
May 16, 2024 (TW) 113118178

(51) Int. Cl. H04B 1/00

(52) U.S. Cl. CPC H04B 1/0064; H04B 1/0057

(57) ABSTRACT

An active distributed antenna communicating method includes the following steps of: a first device receiving M×N radio frequency signals respectively sent by L base stations and determining the radio frequency signals to generate a TDD timing signal; the first device determining the downlink communication mode according to the TDD timing signal; the first device down-converting and dividing the M×N radio frequency signal into L×M downlink signals, and creating a downlink signal group according to the L×M downlink signals; the first device transmitting the downlink signal group to at least one second device through at least one coaxial cable; and the at least one second device up-converting the downlink signal group to L×M radio frequency signals and sending the L×M radio frequency signals.

### BACKGROUND OF THE INVENTION

### 1. Field of the Invention

The present invention relates to the field of communications, especially to an active distributed antenna communicating method and system for transmitting multiple MIMO signals through the traditional passive distributed antenna architecture.

### 2. Description of the Prior Art

In recent years, various communication devices have been widely used in daily life. Taking the smart phone as an example, when the smart phone transmits data or signals, the smart phone will be communicated with the base station through uplink signals and downlink signals via wireless channels. However, the location where users use their smart phones and environmental factors will affect the transmission quality of wireless channels. Especially when users are indoors or in basements of buildings (such as office buildings, residences, hotels, hospitals, etc.), the signal transmission of the base station is severely blocked, resulting in poor communication quality or even signal interruption. Therefore, the distributed antenna system has been developed and arranged in buildings to solve the problem of indoor coverage of communication signals.

In general, most of the current distributed antenna systems are passive distributed antenna system, which transmit the signal of the base station to the indoor through coaxial cables, and send the signal through the passive antenna to communicate with the user's smart phone. However, with the rapid development of communication technology and the rise of 5G signal transmission, the coaxial cables of the current distributed antenna system will produce serious signal loss when transmitting high-frequency signals, thereby reducing signal quality. Furthermore, the signal loss caused by the transmission of high-frequency signals through the coaxial cable will also reduce the signal strength, thereby reducing the signal transmission efficiency. Moreover, the current distributed antenna system has only one communication interface and can only perform SISO transmission (Single In Single Out), which cannot support the communication requirements of high-frequency and high-speed signals. In addition, if the cables of the current distributed antenna system are modified to capable of transmitting high-frequency signals, it will spend a lot of construction time and material costs.

### SUMMARY OF THE INVENTION

Therefore, one category of the present invention provides an active distributed antenna communicating method for multi MIMO signal transmission over traditional passive distributed antenna system. In one embodiment, the active distributed antenna communicating method includes the following steps of: a first device receiving M×N radio frequency signals sent by L base stations respectively and determining the M×N radio frequency signals to generate a TDD timing signal; the first device determining a downlink communication mode according to the TDD timing signal; the first device down-converting and dividing the M×N radio frequency signals into L×M downlink signals and creating a downlink signal group according to the L×M downlink signals; the first device transmitting the downlink signal group and the TDD timing signal to at least one second device through at least one coaxial cable; and the at least one second device up-converting the downlink signal group to L×M radio frequency signals and sending the L×M radio frequency signals. wherein, L, M and N are natural numbers.

Wherein, the step of the first device transmitting the downlink signal group and the TDD timing signal to the at least one second device through the at least one coaxial cable further includes the following steps of: the first device transmitting the downlink signal group and the TDD timing signal to a relay device in optical transmission manner through a first fiber; and the relay device transmitting the downlink signal group and the TDD timing signal to the at least one second device through the at least one coaxial cable.

Wherein, the active distributed antenna communicating method further includes the following step of: the relay device selectively compensating a downlink signal strength of the downlink signal group.

Wherein, the active distributed antenna communicating method further includes the following steps of: the first device determining an uplink communication mode according to the TDD timing signal; the at least one second device receiving a device signal of at least one third device; the at least one second device down-converting and dividing the device signal into L×N uplink signals and creating an uplink signal group according to the L×N uplink signals; the at least one second device transmitting the uplink signal group to the first device through the at least one coaxial cable; and the first device up-converting the uplink signal group to L×N device signals and sending the L×N device signals to the L base stations.

Wherein, the step of the at least one second device transmitting the uplink signal group to the first device through the at least one coaxial cable further includes the following steps of: the at least one second device transmitting the uplink signal group to the relay device through the at least one coaxial cable; and the relay device transmitting the uplink signal group to the first device in optical transmission manner through a second fiber.

Wherein, the downlink signal group includes a downlink frequency range, and the uplink signal group includes an uplink frequency range. The downlink frequency range is less than a frequency threshold value, and the uplink frequency range is greater than the frequency threshold value.

In one embodiment, the downlink signal group includes a downlink frequency range, and the uplink signal group includes an uplink frequency range. The downlink frequency range is greater than a frequency threshold value, and the uplink frequency range is less than the frequency threshold value.

Wherein, the frequency values of the L×M downlink signals are all different, and the frequency values of the L×N uplink signals are all different.

Wherein, the step of the at least one second device up-converting the downlink signal group to the L×M radio frequency signals and sending the L×M radio frequency signals further includes the following steps of: the at least one second device up-converting the downlink signal group to the L×M radio frequency signals; the at least one second device compensating the signal strength of the L×M radio frequency signals according to a transmission path of the at least one coaxial cable; and the at least one second device sending the compensated L×M radio frequency signals.

Another one category of the present invention provides an active distributed antenna communicating system. In one embodiment, active distributed antenna communicating system includes a first device and at least one second device. The first device is communicated with L base stations and includes a plurality of communication interfaces, a signal determining unit and a first down-converting unit. The plurality of communication interfaces are configured to receive M×N radio frequency signals sent by L base stations respectively. The signal determining unit is configured to determine the all radio frequency signals to generate a TDD timing signal, and determine whether the communication mode is one of an uplink communication mode and a downlink communication mode according to the TDD timing signal. The first down-converting unit is configured to down-convert and divide the M×N radio frequency signals into L×M downlink signals, and create a downlink signal group according to the L×M downlink signals. The at least one second device is communicated with the first device through at least one coaxial cable and configured to receive the downlink signal group. The at least one second device includes a first up-converting unit and at least one antenna. The first up-converting unit is configured to up-convert the downlink signal group to L×M radio frequency signals. The at least one antenna is configured to send the L×M radio frequency signals. Wherein, L, M and N are natural numbers.

Wherein, the at least one second device includes a second down-converting unit, and the first device includes a second up-converting unit. The at least one second device is configured to receive a device signal of a third device. The at least one second device is configured to down-convert and divide the device signal into L×N uplink signals and create an uplink signal group according to the L×N uplink signals, and transmit the uplink signal group to the first device. The first device up-converts the uplink signal group to L×N device signals and sends the L×N device signals to the L base stations.

Wherein, the active distributed antenna communicating system further includes a relay device communicated with the first device and the at least one second device. The first device transmitting the downlink signal group and the TDD timing signal to the relay device through a first fiber, and the relay device transmitting the uplink signal group to the first device through a second fiber.

Wherein, the relay device includes a compensating unit. The compensating unit is configured to selectively compensate a downlink signal strength of the downlink signal group.

Wherein, the at least one second device includes a power amplifier. The at least one second device compensates the signal strength of the L×M radio frequency signals according to the power amplifier and a transmission path of the at least one coaxial cable.

In summary, the active distributed antenna communicating method and system can achieve good high-frequency signal coverage when high-frequency signals are applied indoors or in spaces with poor signals through up-convert and down-convert signal conversion and active signal compensation, thereby further improving network transmission efficiency and stability. Furthermore, the active distributed antenna communicating method and system of the present invention can use the traditional passive distributed antenna system to transmit high-frequency signals by reducing the signal frequency, without the need to re-wire or modify the cable, thereby reducing construction costs. Moreover, the active distributed antenna communicating method and system can transmit multi-channel MIMO signals through only two fibers, without the need for multiple fibers to transmit MIMO signals of different frequencies respectively. It can not only simplify circuit configuration and reduce wire complexity, but also transmit communication signals more quickly, thereby saving costs and improving transmission efficiency. In addition, the active distributed antenna communicating method and system can stagger the downlink signal and the uplink signal through the frequency threshold, thereby reducing the internal signal interference.

### BRIEF DESCRIPTION OF THE APPENDED DRAWINGS

FIG. 1 is a step flowchart diagram illustrating an active distributed antenna communicating method in an embodiment of the present invention.

FIG. 2 is a structural schematic diagram illustrating an active distributed antenna communicating system in an embodiment of the present invention.

FIG. 3 is a step flowchart diagram illustrating the active distributed antenna communicating method in an embodiment of the present invention.

FIG. 4 is a step flowchart diagram illustrating the active distributed antenna communicating method in an embodiment of the present invention.

FIG. 5 is a structural schematic diagram illustrating the active distributed antenna communicating system in an embodiment of the present invention.

FIG. 6 is a function block diagram illustrating the active distributed antenna communicating system in an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

The indefinite articles “a”, “an” and “one” before a device or an element of the present invention do not restrict the quantity requirement (ie the number of times the devices or elements appear). Therefore, “a”, “an” and “one” should be read to include one or at least one, and the singular means or elements also include the plural unless the number is obviously meant to be singular.

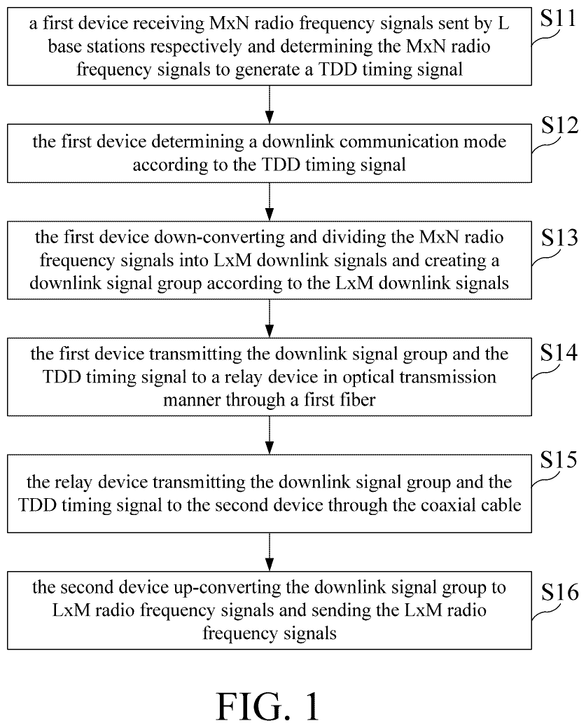

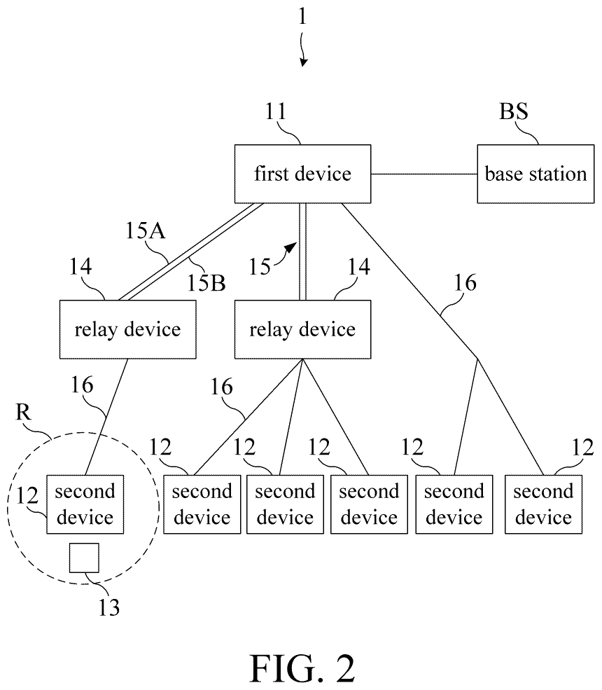

Please refer to FIG. 1 and FIG. 2. FIG. 1 is a step flowchart diagram illustrating an active distributed antenna communicating method in an embodiment of the present invention. FIG. 2 is a structural schematic diagram illustrating an active distributed antenna communicating system 1 in an embodiment of the present invention. The steps in FIG. 1 can be described by the system in FIG. 2. As shown in FIG. 1 and FIG. 2, in this embodiment, the active distributed antenna communicating method includes the following steps of: step S11: a first device 11 receiving M×N radio frequency signals sent by L base stations BS respectively and determining the M×N radio frequency signals to generate a TDD timing signal; step S12: the first device 11 determining a downlink communication mode according to the TDD timing signal; step S13: the first device 11 down-converting and dividing the M×N radio frequency signals into L×M downlink signals and creating a downlink signal group according to the L×M downlink signals; step S14: the first device 11 transmitting the downlink signal group and the TDD timing signal to a relay device 14 in optical transmission manner through a first fiber 15A; step S15: the relay device 14 transmitting the downlink signal group and the TDD timing signal to the at least one second device 12 through the at least one coaxial cable 16; and step S16: the at least one second device 12 up-converting the downlink signal group to L×M radio frequency signals and sending the L×M radio frequency signals.

The active distributed antenna communicating system 1 includes a base station BS, a first device 11, a relay device 14, a second device 12 and a third device 13. The first device 11 is communicated with the base station BS and the relay device 14, and the second device 12 is communicated with the relay device 14 and the third device 13. As shown in FIG. 2, the first device 11 can be connected to at least one relay device 14 simultaneously. Each relay device 14 can be connected to at least one second device 12 simultaneously, and each second device 12 can be connected to multiple third devices 13 simultaneously. It should be noted that the structural of the active distributed antenna communicating system 1 in FIG. 2 can be described the multiple embodiments of the present invention. In practice, the numbers and connecting types of the first device, the relay device, the second device and the third device are not limited to that shown in FIG. 2. The following will describe in detail under the system in which the number of each device is 1.

In step S11, the base station BS can be a fixed high-power bidirectional transmitter, and can send a radio frequency signal (RF signal) and a TDD timing signal. In practice, the RF signal can be 4G/5G time division duplexing signal (TDD signal), but it is not limited hereto. The RF signal can also be higher frequency signal. The RF signal has a RF signal frequency. The TDD timing signal can be a time sequence of the sending signal and receiving signal executed by the base station BS. The base station BS can send M×N MIMO RF signals, wherein M is the number of downlink signals, and N is the number of uplink signals. For example, when the base station BS sends 5G TDD timing signals, the RF signals can be 4×4 MIMO signals; when the base station BS sends 4G TDD timing signals, the RF signals can be 2×2 MIMO signals. It is should be noted that M and N can be different, that is the RF signals can be 6×4 MIMO signals. The first device 11 can be a main signal processing device and include a plurality of communication interfaces to receive the RF signals sent by the base station BS. In practice, the number of the communication interfaces of the first device 11 can be determined according to the type and number of the RF signals. For example, when the RF signal is 5G TDD timing signal, the first device 11 can include four communication interfaces (that is 4×4 MIMO transmission); when the RF signal is 4G TDD timing signal, the first device 11 can include two communication interfaces (that is 2×2 MIMO transmission). Furthermore, the number of the communication interfaces also can be the maximum value between M and N, and each of communication interfaces can be corresponding to different signal frequency bands. Moreover, the first device 11 can generate the TDD timing signals according to the signal strength of the M×N MIMO RF signals sent by the base station BS.

In step S12, the first device 11 can judge and determine the communication mode of the active distributed antenna communicating system 1 according to the TDD timing signal. In practice, when the base station BS is in the time sequence of sending signals, the first device 11 determines that the system is in the downlink communication mode. At this time, the active distributed antenna communicating system 1 transmits the RF signals sent by the base station BS to the third device 13. When the base station BS is in the time sequence of receiving signals, the first device 11 determines that the system is in the uplink communication mode. At this time, the active distributed antenna communicating system 1 transmits the signals sent by the third device 13 to the base station BS. This embodiment will describe the signal transmission of the system in the downlink communication mode.

In step S13, the first device 11 determines that the communication mode is downlink, the first device 11 down-converts and divides the RF signals sent by the base station BS into M downlink signals, and all the down-converted downlink signals have different frequency values respectively. Then, the first device 11 creates a downlink group from the M downlink signals, and the downlink group has a downlink frequency range. The downlink frequency range of the downlink group can be design according to the allowable transmission frequency range of the coaxial cable. Since the frequency of each downlink signal is different, each downlink signal in the downlink signal group will not be interfered and affected by each other.

In step S14, the first device 11 can be connected with the relay device 14 through a first fiber 15A and transmit the downlink signal group to the relay device 14. In practice, the relay device 14 can be a splitter or a coupler, and have a directional transmission function. The first device 11 can include a first transmitter, and the relay device 14 can include a first receiver. The first fiber 15A can be connected to the first transmitter and the first receiver. When the first device 11 transmits the downlink signal group and the TDD timing signal to the relay device 14 through the first fiber 15A, the first transmitter of the first device 11 can convert the electrical signal of the downlink signal group into the optical signal and transmit it to the relay device 14. Then, the first receiver of the relay device 14 converts the optical signal sent by the first transmitter into the electrical signal to receive the downlink signal group.

In step S15, the relay device 14 can include communication interface of the coaxial cable 16 and be connected to the second device 12 through the coaxial cable 16. After the relay device 14 receives the downlink signal group and the TDD timing signal sent by the first device 11 through the first fiber 15A, the relay device 14 can transmit the downlink signal group and the TDD timing signal to the second device 12 through the coaxial cable 16. In practice, the coaxial cable 16 can be a multi-core coaxial cable, and the number of wire cores can include the number of downlink signals. For example, when the downlink signal group includes four downlink signals, the coaxial cable 16 can include four wire cores to form four downlink signal transmitting channels. Each wire core can transmit the corresponding frequency value of the downlink signal. That is, when the relay device 14 transmits the downlink signal group and the TDD timing signal to the second device 12, each downlink signal and the TDD timing signal will be transmitted through the corresponding wire core of the coaxial cable 16.

In step S16, after receiving the downlink signal group, the second device 12 up-converts the M downlink signals of the downlink signal group to RF signal frequencies of the RF signals respectively to form the M RF signals. In practice, the second device 12 can include M antenna configured for signal transmission with the third device 13 located in a preset signal range R. The number of the antenna can be corresponding to the number of the transmission interface and/or the number of the downlink signal of the RF signal. Each antenna can be corresponding to the frequency of one downlink signal and corresponding to the signal band of one communication interface. After the M downlink signals are restored into the M RF signals, the second device 12 can send RF signals through M antennas respectively for the third device 13 to receive. In practical application, the third device 13 can be a smart phone, a notebook, a tablet and the device with data transmission function, and can be communicated with the second device 12 through wireless transmission.

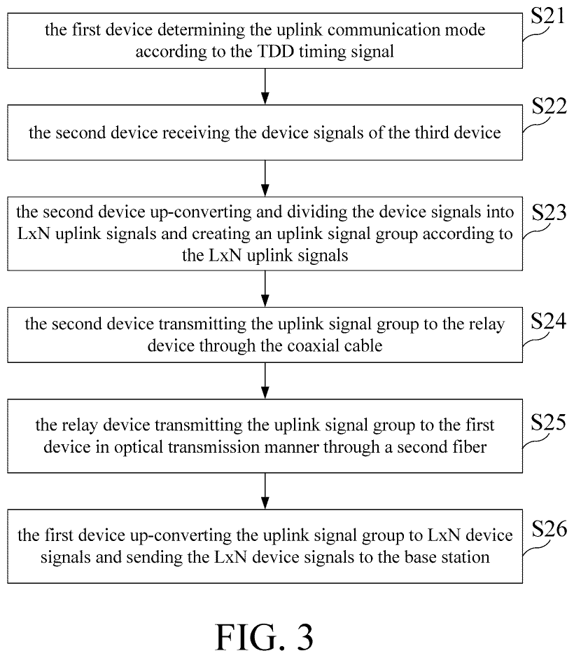

Please refer to FIG. 2 and FIG. 3. FIG. 3 is a step flowchart diagram illustrating the active distributed antenna communicating method in an embodiment of the present invention. The steps in FIG. 3 can be described by the system in FIG. 2. The following will describe the signal transmission of the system in the uplink communication mode. As shown in FIG. 3, in this embodiment, the active distributed antenna communicating method further includes the following steps of: step S21: the first device 11 determining the uplink communication mode according to the TDD timing signal; step S22: the second device 12 receiving a device signal of the third device 13; step S23: the second device 12 down-converting and dividing the device signal into N uplink signals and creating an uplink signal group according to the N uplink signals; step S24: the second device 12 transmitting the uplink signal group to the relay device 14 through the coaxial cable 16; step S25: the relay device 14 transmitting the uplink signal group to the first device 11 in optical transmission manner through a second fiber 15B; and step S26: the first device 11 up-converting the uplink signal group to the N device signals and sending the N device signals to the base station BS.

In step S21, when the base station BS is in the time sequence of receiving signals, the first device 11 determines that the system is in the uplink communication mode. At this time, the first device 11 can send a switch signal and broadcasts the switch signal to the relay device 14 and the second device 12. Furthermore, the first receiver of the second device will stop to receive signals, and the antenna of the second device 12 also will stop to send signals. Moreover, when the base station BS is in the time sequence of receiving signals, the third device 13 can start to send signals.

In step S22, when the second device 12 receives the switch signal sent by the first device 11, the antenna of the second device 12 also can change from the signal sending mode to the signal receiving mode, to receive the device signal of the third device 13. In practice, the antenna of the second device 12 can receive the device signals of different third devices 13. The device signal also has a device signal frequency.

In step S23, after receiving the device signal, the second device 12 down-converts and divides the device signal into N uplink signals, and all the down-converted uplink signals have different frequency values respectively. Then, the second device 12 creates a downlink group from the N uplink signals, and the uplink group has an uplink frequency range. Similarly, the uplink frequency range of the uplink group can be design according to the allowable transmission frequency range of the coaxial cable. Since the frequency of each uplink signal is different, each uplink signal in the uplink signal group will not be interfered and affected by each other. It should be noted that the number of the antenna can also be the number of the uplink signals in the RF signal, or the maximum value between M and N.

In step S24, the number of wire cores of the coaxial cable 16 can include the number of uplink signals. For example, when the uplink signal group includes four uplink signals, the coaxial cable 16 can include four wire cores to form four uplink signal transmitting channels. Each wire core can transmit the corresponding frequency value of the uplink signal. That is, when the second device 12 transmits the uplink signal group to the relay device 14, each uplink signal will be transmitted through the corresponding wire core of the coaxial cable 16. In practical application, the coaxial cable 16 includes eight wire cores, wherein the four wire cores are configured to transmit the downlink signal group from the relay device 14 to the second device 12, and the other four wire cores are configured to transmit the uplink signal group from the second device 12 to the relay device 14.

In step S25, the relay device 14 can include a second transmitter, the first device 11 can include a second receiver, and the second fiber 15B can be connected to the second transmitter and the second receiver. When the relay device 14 transmits the uplink signal group to the first device 11 through the second fiber 15B, the second transmitter of the relay device 14 can convert the electrical signal of the uplink signal group into the optical signal and transmit it to the first device 11. Then, the second receiver of the first device 11 converts the optical signal sent by the second transmitter into the electrical signal to receive the uplink signal group.

In step S26, after receiving the uplink signal group, the first device 11 up-converts the N uplink signals of the uplink signal group to device signal frequencies of the device signals respectively to form the N device signals. Finally, the first device 11 transmits the corresponding device signals to the base station BS through the communication interfaces.

Therefore, the active distributed antenna communicating method of the present invention can down-convert the high-frequency RF signals sent by the base station to a frequency range that can be transmitted by the coaxial cable first, and then up-convert the down-converted signals to the same RF signal of the base station, so that the user's device can receive the signals. Moreover, the active distributed antenna communicating method of the present invention also can down-convert the device signals sent by the user's device to a frequency range that can be transmitted by the coaxial cable first, and then up-convert the down-converted signals to the same device signals of the user's device and send the device signals to the base station, to maintain the signal transmission quality. In addition, the active distributed antenna communicating method of the present invention can transmit multi-channel MIMO signals through only two fibers, without the need for multiple fibers to transmit MIMO signals of different frequencies respectively. It can not only simplify circuit configuration and reduce wire complexity, but also transmit communication signals more quickly, thereby saving costs and improving transmission efficiency.

The active distributed antenna communicating method and system of the present invention also can receive the MIMO RF signals sent by a plurality of base stations simultaneously. In one embodiment, the first device receives M×N RF signals respectively sent by L base stations. In practice, since the communication interfaces of the first device are corresponding to different signal frequency bands respectively, the communication interfaces of the first device can respectively receive the RF signals from L base stations in the same signal frequency band. Then, the first device down-converts and divides the all RF signals into L×M downlink signals and creates the downlink signal group according to the L×M downlink signals. In practice, the downlink signal group can further include a plurality of downlink signal sub-groups. Each downlink signal sub-group can correspond to a frequency interval value, and the number of downlink signal sub-groups can correspond to the number of antennas. Therefore, the first device can classify the down-converted L×M downlink signals into corresponding downlink signal sub-groups. Then, the first device transmits the downlink signal group and the TDD timing signal to the second device through the relay device. Finally, the second device up-converts the downlink signal group to the L×M RF signals and sends the L×M radio frequency signals to send out signals of multiple base stations simultaneously.

It should be noted that the number of the communication interface of the first device also can be determined according to the RF signal types. For example, a first base station sends 4×4 MIMO signals, a second base station sends 2×2 MIMO signals, and then the number of the communication interface is six. Moreover, the number of the communication interface also can be determined according to the RF signal types and frequency band. In one embodiment, the number of the communication interface of the first device is eight and configured to receive 4×4 MIMO RF signals and two sets of 2×2 MIMO RF signals with different frequency bands.

Similarly, after receiving the device signals sent by the plurality of the third devices, the second device down-converts and divides the all device signals into L×N uplink signals and creates the uplink signal group according to the L×N uplink signals. In practice, the uplink signal group can further include a plurality of uplink signal sub-groups. Each uplink signal sub-group can correspond to a frequency interval value. Therefore, the second device can classify the down-converted L×N uplink signals into corresponding uplink signal sub-groups. Then, the second device transmits the uplink signal group to the first device through the relay device. Finally, the first device up-converts the uplink signal group to the L×N device signals and sends the L×N device signals to the base stations.

In this embodiment, the first device 11 can down-convert the RF signals according to a frequency threshold value, and the second device 12 can down-convert the device signals according to the frequency threshold value. In step S13, the first device 11 down-converts and divides the RF signals into M downlink signals and creates the downlink signal group, and adjusts the downlink frequency range of the downlink signal group to be greater than the frequency threshold value. Furthermore, in step S23, the second device 12 down-converts and divides the device signals into N uplink signals and creates the uplink signal group, and adjusts the uplink frequency range of the uplink signal group to be smaller than the frequency threshold value. In practice, the frequency threshold value can be the allowable transmission frequency range of the coaxial cable and can be determined as requirement or design. Since the downlink frequency range of all the downlink signals are greater than the frequency threshold value and the uplink frequency range of all the uplink signals are smaller than the frequency threshold value, the frequency ranges of the downlink signal group and the uplink signal group can be staggered with each other, and the downlink signal group and the uplink signal group will not interfere with each other. The downlink signal group, the uplink signal group and the frequency threshold value are not limited to the above-mentioned forms. In one embodiment, the first device can adjust the downlink frequency range of the downlink signal group to be smaller than the frequency threshold value, and the second device also can adjust the uplink frequency range of the uplink signal group to be greater than the frequency threshold value.

Please refer to FIG. 1 and FIG. 2. As shown in FIG. 1 and FIG. 2, the first device 11 also can be communicated with two relay devices 14 through two sets of the fiber (each set of the fiber includes aforementioned the first fiber and the second fiber), and the two relay devices 14 are communicated with one the second device 12 and three the second devices respectively. In practical application, after receiving the RF signals of the base station BS and creating the downlink signal group according to the RF signals, the first device 11 can copy the downlink signal group into two downlink signal groups and transmit the two downlink signal groups to the two relay devices 14 simultaneously. Moreover, the relay device 14 also can copy at least one downlink signal group according to the amount of the second device 12 respectively and transmit the downlink signal group to the second device 12.

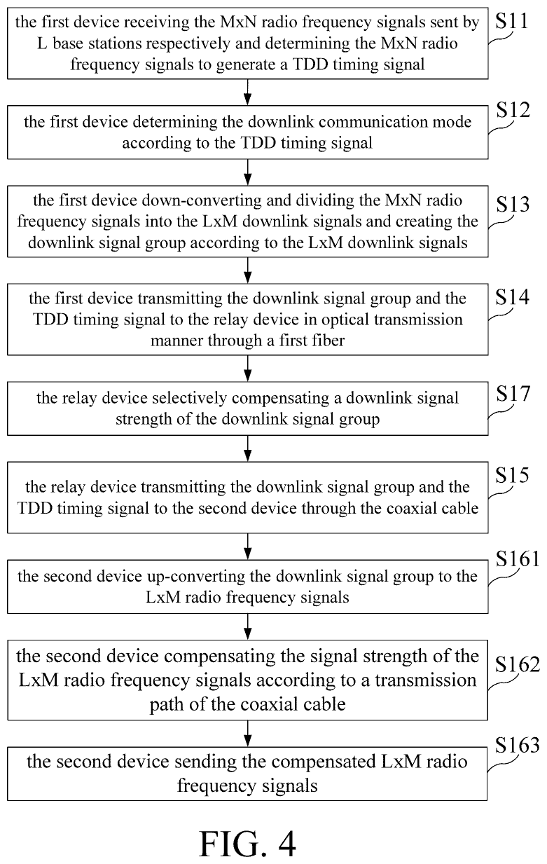

Please refer to FIG. 2 and FIG. 4. FIG. 4 is a step flowchart diagram illustrating the active distributed antenna communicating method in an embodiment of the present invention. The step flowchart in FIG. 4 can be the further steps in FIG. 1. As shown in FIG. 4, in this embodiment, the active distributed antenna communicating method further includes the following step of: step S17: the relay device 14 selectively compensating a downlink signal strength of the downlink signal group. Moreover, the step S16 in FIG. 1 can further include the following steps of: step S161: the second device 12 up-converting the downlink signal group to the M RF signals; step S162: second device 12 compensating the signal strength of the M RF signals according to a transmission path of the coaxial cable 16; and step S163: the second device 12 sending the compensated M RF signals.

In step S17, when the first device 11 transmits the downlink signal group to the relay device 14, the signal strength of the downlink signal group may be reduced due to the length of the first fiber 1A (that is the distance between the first device 11 and the relay device 14). Therefore, the relay device 14 can compensate the downlink signals of the downlink signal group to certain signal strength, to ensure that the downlink signal group can be transmitted to the second device 12. In practice, the compensating value of the downlink signal group can be determined according to the distance between the relay device 14 and the second device 12. In addition, the relay device 14 compensates the signal strength of the downlink signal group, that is to say, the relay device 14 can directly compensate the M downlink signals simultaneously without compensating them separately, thereby improving the signal compensation efficiency.

In step S162, when the relay device 14 transmits the downlink signal group to the second device 12, the signal strength of the downlink signal group may be reduced due to the transmission path of the coaxial cable 16 (that is the distance between the relay device 14 and the second device 12). Therefore, after the step S161, the second device 12 will compensate the M RF signals according to the transmission path of the coaxial cable 16, so that the M RF signals can cover the predetermined signal range R.

Similarly, when the first device receives the M×N RF signals sent by the L base stations, the relay device can selectively compensate the downlink signal strengths of the L×M downlink signals in the downlink signal group. The second device also can up-convert the downlink signal group to L×M RF signals and compensate the signal strengths of the L×M RF signals according to the transmission path of the coaxial cable, and then sends the compensated L×M RF signals.

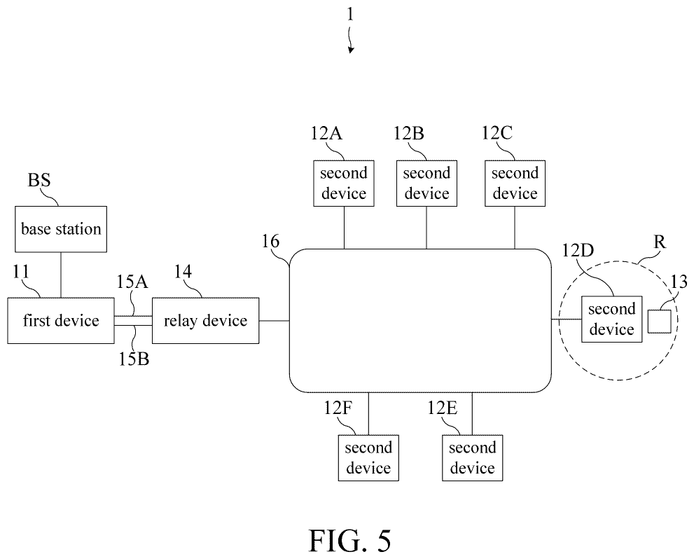

The active distributed antenna communicating system 1 of the present invention also can be applied and replaced current passive distributed antenna system architecture (Passive DAS). Please refer to FIG. 5. FIG. 5 is a structural schematic diagram illustrating the active distributed antenna communicating system 1 in an embodiment of the present invention. As shown in FIG. 5, in this embodiment, the coaxial cables 16 between the relay device 14 and the second devices (12A to 12F) are the circuits of the passive distributed antenna system. The coaxial cables 16 can include a plurality of nodes, and the second devices (12A to 12F) can be configured on the nodes respectively. When the first device 11 transmits the downlink signal group created from the RF signals of the base station and the relay device 14 receives and sends the downlink signal groups to the second devices, the downlink signal groups can transmit to the nodes in sequence to the second devices (12A to 12F), and then the second devices (12A to 12F) can compensate the N RF signals according to the signal strength of the downlink signal group and the preset signal range R. It should be noted that the compensation values of N RF signals generated from each of the second devices can be different. As shown in FIG. 5, the transmission path between the second device 12A and the relay device 14 is shorter, which means that the signal attenuation of the downlink signal group transmitted by the relay device 14 is less. Therefore, the compensation value of the N RF signals generated from the second device 12A is smaller. The transmission path between the second device 12D and the relay device 14 is longer, which means that the signal attenuation of the downlink signal group transmitted by the relay device 14 is greater. Therefore, the compensation value of the N RF signals generated from the second device 12D is greater.

In practical application, the first device 11 can be communicated with the base station through the cable or placed in a location with good signal to communicate with the base station wirelessly, so as to serve as a signal source of the active distributed antenna communicating system 1. The coaxial cable 16 (or the coaxial circuit of current distributed antenna communicating system) can be disposed at the location where the signal is poor or where high frequency radio frequency signals cannot be received, such as basements, locations far from windows in low-to mid-rise buildings, high-rise buildings, etc. The second device 12 can be disposed on the node of the coaxial cable 16. The relay device 14 can be disposed at a relay position between the first device 11 and the coaxial cable 16 (such as equipment room on each floor of the building). As aforementioned, after the first device 11 transmits the downlink signal group created according to the RF signals of the base station to the relay device 14, the relay device 14 can transmit the downlink signal group that has been down-converted and can be transmitted through the coaxial cable 16 to the location where the signal is poor, the high-frequency radio frequency signal cannot be received, or to the circuit of the original passive distributed antenna system. Finally, the second device 12 can up-convert the downlink signal group to RF signal and compensate the signal strength of the RF signal actively.

Therefore, the active distributed antenna communicating method of the present invention can use the traditional passive distributed antenna system to transmit high-frequency signals by reducing the signal frequency, without the need to re-wire or modify the cable, thereby reducing construction costs. Furthermore, the active distributed antenna communicating method of the present invention can actively up-convert the signal equal to the RF signal sent by the base station, so that the high-frequency signal can have good high-frequency signal coverage when used indoors or in places with poor signals, further improving network transmission efficiency and stability.

It should be noted that the architecture of the active distributed antenna communicating system in FIG. 5 is not limited thereto. In practice, the first device also can be connected to a plurality of relay devices, and each of the relay devices also can be connected to the circuit of a passive distributed antenna system respectively.

Please refer to FIG. 1 and FIG. 2. As shown in FIG. 2, in one embodiment, the active distributed antenna communicating system 1 also can only include a first device 11 and at least one second device 12, without the relay device. In this embodiment, the first device 11 can be directly connected to the second device 12 through the coaxial cable 16. After receiving the RF signal of the base station BS and down-converting the RF signal to generate the downlink signal group, the first device 11 can directly transmit the downlink signal group to the second device 12 through the coaxial cable 16, and the second device 12 up-converts the downlink signal group into the RF signal and sends the RF signal. Similarly, After receiving the device signals of the third device and down-converting the device signals to generate the uplink signal group, the second device 12 can directly transmit the uplink signal group to the first device 11 through the coaxial cable 16, and the first device 11 up-converts the uplink signal group into the device signals and sends the device signals to the base station. The system architecture of this embodiment can be applied to the case where the distance between the first device and the second device is short.

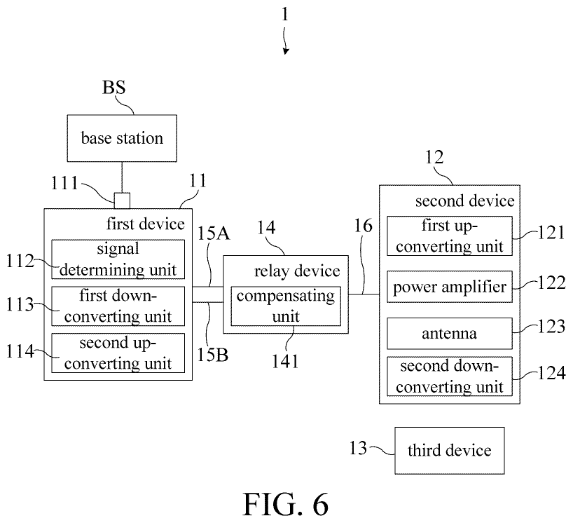

Please refer to FIG. 2 and FIG. 6. FIG. 6 is a function block diagram illustrating the active distributed antenna communicating system 1 in an embodiment of the present invention. All aforementioned steps can be achieved by the active distributed antenna communicating system 1 in FIG. 6, and the system of FIG. 6 can correspond to the system in FIG. 2. As shown in FIG. 6, in this embodiment, the active distributed antenna communicating system 1 includes a first device 11, a relay device 14 and at least one second device 12. The first device 11 is communicated with the base station BS and communicated with the relay device 14 through a first fiber 15A and a second fiber 15B. The relay device 14 is communicated with the second device 12 through at least one coaxial cable 16.

The first device 11 includes a plurality of communication interfaces 111, a signal determining unit 112 and a first down-converting unit 113. The plurality of communication interfaces 111 are configured to receive M×N radio frequency signals sent by L base stations BS respectively. The signal determining unit 112 is configured to determine the radio frequency signals to generate a TDD timing signal, and determine whether the communication mode is one of an uplink communication mode and a downlink communication mode according to the TDD timing signal. The first down-converting unit 113 is configured to down-convert and divide the radio frequency signals into M downlink signals and create a downlink signal group according to the M downlink signals. In practice, the signal determining unit 112 can be a RF switch or a RF switch combined with a controlling chip. The signal determining unit 112 can change the RF switch according to the TDD timing signal to control the first device 11 execute the uplink communication mode or the downlink communication mode. The first down-converting unit 113 can be a down-converter and configured to down-convert and divide the RF signals into the M downlink signals greater than the frequency threshold value and generate the downlink signal group.

The relay device 14 receives the downlink signal group generated by the first device 11 in optical transmission manner through the first fiber 15A, and transmits the downlink signal group to the second device 12 through the coaxial cable 16. Furthermore, the relay device 14 includes a compensating unit 141 configured to compensate the downlink signal strength of the downlink signal group. In practice, the compensating unit 141 can be a power amplifier. The relay device 14 can selectively compensate the downlink signal strength of the downlink signal group by the compensating unit 141. The second device 12 includes a first up-converting unit 121, a power amplifier 122 and at least one antenna 123. The first up-converting unit 121 is configured to up-convert the downlink signal group to M radio frequency signals. The power amplifier 122 is configured to compensate the signal strength of the radio frequency signals. The antenna 123 is configured to send the M radio frequency signals to at least one third device 13. In practice, the first up-converting unit 121 can be an up-converter.

In practical application, the communication interface 111 of the first device 11 receives the RF signals of the base station BS. The signal determining unit 112 generates the TDD timing signal according to the RF signals and determines the communication mode according to the TDD timing signal. When the signal determining unit 112 determines that the system is in the downlink communication mode, the first down-converting unit 113 of the first device 11 down-converts the RF signals to create the downlink signal group. Wherein, the first device 11 can transmit the downlink signal group to the relay device 14 through the first fiber 15A, the relay device 14 selectively compensates the signal strength of the downlink signal group through the compensating unit 141, and transmits the downlink signal group to the second device 12 through the coaxial cable 16; or the first device 11 also can directly transmit the downlink signal group to the second device 12 through the coaxial cable 16. Then, the first up-converting unit 121 of the second device 12 up-converts the downlink signal group to the M RF signals, and compensates the signal strength of the RF signals according to the power amplifier 122 and the preset signal range R. Finally, the antenna 123 of the second device 12 sends the compensated M RF signals.

Moreover, in this embodiment, the second device 12 further includes a second down-converting unit 124, and the first device 11 includes a second up-converting unit 114. In practice, the second down-converting unit 124 can be a down-converter configured to down-convert and divide the device signals into the N uplink signals smaller than the frequency threshold value and generate the uplink signal group. The second up-converting unit 114 is configured to up-convert the N uplink signals to the device signals.

In practice, when the signal determining unit 112 of the first device 11 determines that the system is in the uplink communication mode, the antenna 123 of the second device 12 receives the device signals sent by the third device 13, the second down-converting unit 124 of the second device 12 down-converts the device signals to create the uplink signal group. Wherein, the second device 12 can transmit the uplink signal group to the relay device 14 through the coaxial cable 16, and the relay device 14 transmits the uplink signal group to the first device 11 through the second fiber 15B; or the second device 12 also can directly transmit the uplink signal group to the first device 11 through the coaxial cable 16. Finally, the second up-converting unit 114 of the first device 11 up-converts the uplink signal group to the device signals, and sends the device signals to the base station BS.

In summary, the active distributed antenna communicating method and system can achieve good high-frequency signal coverage when high-frequency signals are applied indoors or in spaces with poor signals through up-convert and down-convert signal conversion and active signal compensation, thereby further improving network transmission efficiency and stability. Furthermore, the active distributed antenna communicating method and system of the present invention can use the traditional passive distributed antenna system to transmit high-frequency signals by reducing the signal frequency, without the need to re-wire or modify the cable, thereby reducing construction costs. Moreover, the active distributed antenna communicating method and system can transmit multi-channel MIMO signals through only two fibers, without the need for multiple fibers to transmit MIMO signals of different frequencies respectively. It can not only simplify circuit configuration and reduce wire complexity, but also transmit communication signals more quickly, thereby saving costs and improving transmission efficiency. In addition, the active distributed antenna communicating method and system can stagger the downlink signal and the uplink signal through the frequency threshold, thereby reducing the internal signal interference.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An active distributed antenna communicating method, comprising the following steps of:
a first device receiving M×N radio frequency signals sent by L base stations respectively and determining the M×N radio frequency signals to generate a TDD timing signal;
the first device determining a downlink communication mode according to the TDD timing signal;
the first device down-converting and dividing the M×N radio frequency signals into L×M downlink signals and creating a downlink signal group according to the L×M downlink signals;
the first device transmitting the downlink signal group and the TDD timing signal to at least one second device through at least one coaxial cable; and
the at least one second device up-converting the downlink signal group to L×M radio frequency signals and sending the L×M radio frequency signals;
wherein, L, M and N are natural numbers.

2. The active distributed antenna communicating method of claim 1, wherein the step of the first device transmitting the downlink signal group and the TDD timing signal to the at least one second device through the at least one coaxial cable further comprises the following steps of:
the first device transmitting the downlink signal group and the TDD timing signal to a relay device in optical transmission manner through a first fiber; and
the relay device transmitting the downlink signal group and the TDD timing signal to the at least one second device through the at least one coaxial cable.

3. The active distributed antenna communicating method of claim 2, further comprising the following step of:
the relay device selectively compensating a downlink signal strength of the downlink signal group.

4. The active distributed antenna communicating method of claim 2, further comprising the following steps of:
the first device determining an uplink communication mode according to the TDD timing signal;
the at least one second device receiving a device signal of at least one third device;
the at least one second device down-converting and dividing the device signal into L×N uplink signals and creating an uplink signal group according to the L×N uplink signals;
the at least one second device transmitting the uplink signal group to the first device through the at least one coaxial cable; and
the first device up-converting the uplink signal group to L×N device signals and sending the L×N device signals to the L base stations.

5. The active distributed antenna communicating method of claim 4, wherein the step of the at least one second device transmitting the uplink signal group to the first device through the at least one coaxial cable further comprises the following steps of:
the at least one second device transmitting the uplink signal group to the relay device through the at least one coaxial cable; and
the relay device transmitting the uplink signal group to the first device in optical transmission manner through a second fiber.

6. The active distributed antenna communicating method of claim 4, wherein the downlink signal group comprises a downlink frequency range, and the uplink signal group comprises an uplink frequency range, the downlink frequency range is less than a frequency threshold value, and the uplink frequency range is greater than the frequency threshold value.

7. The active distributed antenna communicating method of claim 4, wherein the downlink signal group comprises a downlink frequency range, and the uplink signal group comprises an uplink frequency range, the downlink frequency range is greater than a frequency threshold value, and the uplink frequency range is less than the frequency threshold value.

8. The active distributed antenna communicating method of claim 4, wherein the frequency values of the L×M downlink signals are all different, and the frequency values of the L×N uplink signals are all different.

9. The active distributed antenna communicating method of claim 1, wherein the step of the at least one second device up-converting the downlink signal group to the L×M radio frequency signals and sending the L×M radio frequency signals further comprises the following steps of:
the at least one second device up-converting the downlink signal group to the L×M radio frequency signals;
the at least one second device compensating the signal strength of the L×M radio frequency signals according to a transmission path of the at least one coaxial cable; and
the at least one second device sending the compensated L×M radio frequency signals.

10. An active distributed antenna communicating system, comprising:
a first device, communicated with L base stations, the first device comprising:
a plurality of communication interfaces, configured to receive M×N radio frequency signals sent by L base stations respectively;
a signal determining unit, configured to determine the radio frequency signals to generate a TDD timing signal, and determine whether the communication mode is one of an uplink communication mode and a downlink communication mode according to the TDD timing signal; and
a first down-converting unit, configured to down-convert and divide the M×N radio frequency signals into L×M downlink signals and create a downlink signal group according to the L×M downlink signals; and
at least one second device, communicated with the first device through at least one coaxial cable and configured to receive the downlink signal group, the at least one second device comprising:
a first up-converting unit, configured to up-convert the downlink signal group to L×M radio frequency signals; and
at least one antenna, configured to send the L×M radio frequency signals;
wherein, L, M and N are natural numbers.

11. The active distributed antenna communicating system of claim 10, wherein the at least one second device comprises a second down-converting unit, and the first device comprises a second up-converting unit, the at least one second device is configured to receive a device signal of a third device, the at least one second device is configured to down-convert and divide the device signal into L×N uplink signals and create an uplink signal group according to the L×N uplink signals, and transmit the uplink signal group to the first device, the first device up-converts the uplink signal group to L×N device signals and sends the L×N device signals to the L base stations.

12. The active distributed antenna communicating system of claim 11, further comprising a relay device communicated with the first device and the at least one second device, the first device transmitting the downlink signal group and the TDD timing signal to the relay device through a first fiber, and the relay device transmitting the uplink signal group to the first device through a second fiber.

13. The active distributed antenna communicating system of claim 12, wherein the relay device comprises a compensating unit, the compensating unit is configured to selectively compensate a downlink signal strength of the downlink signal group.

14. The active distributed antenna communicating system of claim 11, wherein the downlink signal group comprises a downlink frequency range, and the uplink signal group comprises an uplink frequency range, the downlink frequency range is less than a frequency threshold value and the uplink frequency range is greater than the frequency threshold value.

15. The active distributed antenna communicating system of claim 11, wherein the downlink signal group comprises a downlink frequency range, and the uplink signal group comprises an uplink frequency range, the downlink frequency range is greater than a frequency threshold value and the uplink frequency range is less than the frequency threshold value.

16. The active distributed antenna communicating system of claim 11, wherein the frequency values of the L×M downlink signals are all different, the frequency values of the L×N uplink signals are all different.

17. The active distributed antenna communicating system of claim 10, wherein the at least one second device comprises a power amplifier, the at least one second device compensates the signal strength of the L×M radio frequency signals according to the power amplifier and a transmission path of the at least one coaxial cable.
